(19) United States
(12) Patent Application Publication
(10) Pub. No.: US 2005/0008761 A1
(43) Pub. Date: Jan. 13, 2005

(54) Modified starches for use in gluten-free baked products

(76) Inventors: Jeanne Paulus, Bridgewater, NJ (US); Peter T. Trzasko, Plainsboro, NJ (US); Susan E. Waring, Hillsborough, NJ (US); Ralph M. Trksak, Manville, NJ (US); Deborah Dihel, Whitehouse Station, NJ (US)

Correspondence Address: David P. LeCroy;NATIONAL STARCH AND CHEMICAL COMPANY, P.O. Box 6500, Bridgewater, NJ, 08807-0500, US

(21) Appl. No.: 10/886,864

(22) Filed: Jul. 8, 2004

Related U.S. Application Data
(60) Provisional application No. 60/486,783, filed on Jul. 11, 2003.

(51) Int. Cl. A23G 3/00

(52) U.S. Cl. 426/658

(57) ABSTRACT

Modified starches for use in baked products. The starches provide exceptional expansion in baked products, as well as improved taste, texture and appearance of the product.

### CROSS REFERENCE TO RELATED APPLICATIONS

This application claims the benefit of U.S. Provisional Application No. 60/486 783 filed 11 Jul. 2003.

### BACKGROUND OF THE INVENTION

1. Technical Field

The present invention relates to modified starches for use in baked products. More specifically, the present invention is directed towards pregelatinized or cold water dispersible, modified starches having improved expansion properties in gluten-free baked products.

2. Background Information

Gluten is a protein found in grains including wheat, oats, barley, and rye. In baked products, gluten forms the viscoelastic matrix of dough, which becomes a firm loaf of bread when baked. It is also very commonly used in packaged foods to prevent crumbling. Unfortunately, individuals that suffer from wheat allergies, wheat or gluten intolerance, multiple food allergies or celiac disease (a permanent, incurable intolerance to gluten that makes it hard to digest essential nutrients) need to avoid gluten. In response to this need, the food industry has created alternative gluten-free products, including gluten-free baked products.

Wheat flour, which can be high in gluten, can be substituted with other flours for baking. These include, for example, rice flour, tapioca starch, potato starch and cornstarch. However, these gluten-free baked goods generally absorb more water than ‘normal’ flours. Further, they also lack the robust structure and texture typical of gluten-containing baked goods. Gluten-free dough needs to be baked in the oven as quickly as possible to ensure the maximum possible rise or expansion.

It is known to use guar gum, xanthan gum and/or modified starch in gluten-free baked products as binder alternatives in those products. Further, modified starches are used as expansion aids in gluten-free products such as bread. However, these gums and modified starches either do not provide the level or amount of expansion demanded, or do so at the sacrifice of taste, texture and/or appearance of the final product.

Starch behavior in baked products is a function of the type of flour used, the product formulation (i.e., the other ingredients such as salts, sugars, emulsifiers, and shortening), processing conditions and final preparation, such as baking or frying requirements. The addition of modified starches to baked goods can provide desirable moisture retention and textures to the final products, in addition to improving the cell structure, providing increased volume and machinability, enhanced shelf life and good particle suspension properties.

The addition of a pregelatinized starch helps bind moisture, thus providing improved tenderness in the final product and contributing to the development of a fine uniform cell structure. As noted above, in certain low or gluten-free systems such a starch may be used as a continuous matrix binder to provide workable dough.

Other known processes combine non-pregelatinized starch with an at least partially pregelatinized starch in order to produce workable dough. For example, U.S. Pat. No. 4,623,548 describes dough prepared by the extrusion of a mixture of a pregelatinized starch, partially gelatinized cereal flour and a native non-pregelatinized starch. The dough is then fried to form the final product. European Patent No. 0847702 describes dough that may be formed into a sheet and/or rolled and folded for pastry. The dough contains a non-pregelatinized starch material, a non-waxy pregelatinized starch, water and fat. This formulation contains significant levels of fat (2% to 7%), which is used to overcome dough texture deficiencies, such as crumbliness and buckiness, in their amylose containing formulation. Such a formulation is baked as a loaf in an oven with the objective of reducing moisture content and producing a partially raised or blistered surface.

International Publication No. WO 01/19195 describes the production of a gluten-free material that mimics gluten. This material is made by heating a mixture of starch, edible oil, edible protein and a liquid for a time and under conditions that form an aerated mass. The material is useful in gluten-free bakery products, including breads, when combined with gluten-free flour. However, the publication provides no teaching as to this composition's expansion abilities.

Fermented starch such as fermented tapioca can also be used in traditional baked product recipes. However, the highly variable quality and consistency of the fermented product requires their use in combination with modified starches. Demiate et al.'s article “Relationship between baking behavior of modified cassava starches and starch chemical structure determined by FTIR spectroscopy”, CARBOHYDRATE POLYMERS, vol. 42, pp. 149-58 (2000), tested the FTIR spectrum and expansion properties of chemically oxidized starches further treated with lactic acid in an attempt to understand the chemical changes responsible for superior expansion properties of fermented tapioca starches. The presence of carboxylate groups (around 1600 cm⁻¹ in the infrared spectral region) on cassava starch, as well as other structural changes in the region around 1060 cm⁻¹ of mean normalized spectral data correlated to expansion properties. Degradative oxidation was assumed to take place on the C—O bond relative to the carbon 1 and oxygen 5 of the cyclic part of glucose at 1060 cm⁻¹. Demiate et al. further determined that acidified cassava starch with lactic acid alone is not sufficient to give desired baking properties. Demiate et al. does not teach or suggest the use of only degradative oxidative treatment, or the use of other starches such as oxidized, crosslinked, pre-gelled starches or hydrophobically treated starches for delivering superior expansion.

Despite the advances noted above, there still remains a need for modified starches that provide exceptional expansion in baked products while providing good flavor and texture for gluten-free baked products, including gluten-free bread.

### SUMMARY OF THE INVENTION

The present invention is directed towards modified starches for use in baked products, as well as the products produced therefrom. The modified starches of the present invention include converted, crosslinked, pre-gelled starches or hydrophobically treated starches for delivering improved expansion. (Examples of hydrophobically treated starches include octenyl succinate anhydride (‘OSA’) treated starches.) Such starches exhibit exceptional expansion properties in gluten-free baked products while maintaining or improving the taste, texture and appearance of the final product.

The carefully processed modified starches of the present invention provide baked products having these desirable properties. These starches provide good moisture retention, which contributes to the superior workability and functionality of dough made therefrom.

The improved dough produced thereby produces advantageously workable dough suitable for use in a number of applications, including but not limited to, use in baked and fried snack products.

### DETAILED DESCRIPTION

The present invention is directed towards modified starches for use in baked products, as well as the products produced therefrom. All starches and flours (hereinafter collectively “starch” or “starches”) may be suitable for use herein and may be derived from any native source. A native starch as used herein, is one as it is found in nature. Also suitable are starches derived from a plant obtained by standard breeding techniques including crossbreeding, translocation, inversion, transformation or any other method of gene or chromosome engineering to include variations thereof. In addition, starches derived from a plant grown from artificial mutations and variations of the above generic composition that may be produced by known standard methods of mutation breeding are also suitable herein.

Typical sources for starches are cereals, tubers, roots, legumes, fruits, stems or trunks. The native source can be corn, pea, potato, sweet potato, banana, barley, wheat rice, sago, amaranth, tapioca, arrowroot, canna, sorghum, and high amylose varieties thereof. Most preferably, the starch is tapioca.

The starch can be converted to its viscosity or thin-boiling form using a suitable method of degradation that results in the modified starch defined herein. Conversion products derived from any of the starches, including fluidity or thin-boiling starches prepared by oxidation, enzyme conversion, acid hydrolysis, heat and or acid dextrinization, and or sheared products may be useful herein.

Commercially, starch is typically converted by acid or enzyme conversion techniques. In preparing starches converted by acid treatment, the granular starch base is hydrolyzed to the required viscosity in the presence of an acid. This is done at a temperature below the gelatinization point of the starch. The starch is slurried in water, followed by addition of the acid, which is usually in concentrated form. Typically, the reaction takes place over an 8 to 16 hour period, after which the slurry is pH adjusted to a pH of about 5.5. The starch can then be recovered by filtration.

In converting starch by enzyme treatment, the granular starch base is slurried in water and pH adjusted from about 5.6 to about 5.7. A small amount of an enzyme such as α-amylase (e.g., about 0.02% on the starch) is added to the slurry. The slurry is then heated above the gelatinization point of the starch. When the desired conversion is reached, the slurry is pH adjusted, e.g., with acid, to deactivate the enzyme. The dispersion is held at the pH necessary to deactivate the enzyme for a period of at least 10 minutes. Thereafter the pH may be readjusted. The resulting enzyme converted starch can be jet-cooked to ensure complete solubilization of the starch and deactivation of the residual enzyme. The type and concentration of the enzyme, the conversion conditions, and the length of conversion contribute to the composition of the resultant product. Other enzymes or combination of enzymes can be used.

Hydrogen peroxide can also be used to convert or thin the starch, either alone or with metal catalysts. Preferably, the starches are Manox converted (e.g., as described in the permanganate-catalyzed peroxide conversion of starch in U.S. Pat. No. 4,838,944) or converted by oxidation.

The base material can be modified chemically and/or physically using techniques known in the art. The modification can be to the base or the converted starch, though typically the modification is carried out after conversion.

Chemically modified starches include without limitation crosslinked, acetylated and organically esterified starches; hydroxyethylated and hydroxypropylated starches; phosphorylated and inorganically esterified starches; cationic anionic, nonionic and zwitterionic starches; and succinate and substituted succinate derivative starches. Such modifications are known in the art, for example, in MODIFIED STARCHES: PROPERTIES AND USES, Ed. Wurzburg, CRC Press, Inc., Florida, pp. 17-196 (1986)

Preparation of hydrophobic starch derivatives can be carried out by procedures known in the art. One such method is disclosed in U.S. Pat. No. 2,661,349, which describes hydrophobic starch derivatives such as starch alkyl or alkenyl succinate. The '349 patent describes an aqueous method in which such derivatives are prepared using a standard esterification reaction where the anhydride reagent and starch are suspended in water and mixed under alkaline conditions. Another method for preparing the hydrophobic starch derivatives is disclosed in U.S. Pat. No. 5,672,699. This patent describes a method for preparing hydrophobic starch derivatives having improved reaction efficiencies wherein the starch and anhydride reagent are predispersed or intimately contacted at low pH before being brought to alkaline reaction conditions. Other disclosures of the starch derivatives and the method of preparation can be found in “Starch: Chemistry and Technology”, ₂nd edition, edited by R. L. Whistler et al., 1988, pp. 341-343 and “Modified Starches: Properties and Uses”, edited by O. Wuirzburg, 1986, Ch. 9, pp. 131-147).

Physically modified starches, such as thermally inhibited starches described in International Publication WO 95/04082, may also be suitable for use herein. Physically modified starches are also intended to include fractionated starches in which there is a higher proportion of amylose.

Preferably, the modified starch is a Manox converted, crosslinked, or succinate or substituted succinate derivative starch. In modifying the starch by crosslinking, it is reacted with any crosslinking agent capable of forming linkages between the starch molecules. Typically crosslinking agents suitable herein are those approved for use in foods, such as epichlorohydrin, linear dicarboxylic acid anhydrides, acrolein, phosphorus oxychloride, and soluble metaphosphates. Preferred crosslinking agents are phosphorus oxychloride, epichlorohydrin, sodium trimetaphosphate (STMP), and adipic-acetic anhydride, and most preferably phosphorus oxychloride and STMP.

The crosslinked, converted starch obtained by the steps outlined above must be pregelatinized to become cold-water dispersible. Various techniques known in the art, including drum drying, spray drying, or jet cooking can pregelatinize these starches. Exemplary processes for preparing pregelatinized starches are disclosed in U.S. Pat. Nos. 1,516,512; 1,901,109; 2,314,459; 2,582,198; 2,805,966; 2,919,214; 2,940,876; 3,086,890; 3,133,836; 3,137,592; 3,234,046; 3,607,394; 3,630,775; 4,280,851; 4,465,702; 5,037,929; 5,131,953, and 5,149,799.

Preferably, pregelatinization is accomplished herein by using a suitable drum dryer having a single drum or double drums that dries the starch to a moisture level of about 12% or less. The starch slurry is typically fed onto the drum or drums through a perforated pipe or oscillating arm from a tank or vat provided with an agitator and a rotor.

After pregelatinization, the starch product is removed from the apparatus and then pulverized to a powder. Alternatively, the product may be reduced to flake form, depending on the particular end-use, although the powdered form is preferred. Any conventional equipment such as a Fitz mill or hammer mill may be used to affect suitable flaking or pulverizing.

The final product obtained from the pregelatinization operation is a cold-water dispersible starch. The determination of gel formation and the measurement of gel strength are accomplished by subjective evaluation and by texture analyzer readings.

The modified starch of the present invention can be used in any amount necessary to achieve the characteristics desired for the particular end-use application. In general, the modified starch is used in an amount of at least about ten percent (10%) of the dry mix level, or at least about three percent (3%) in dough.

The following examples are presented to further illustrate and explain the present invention and should not be taken as limiting in any regard. All parts and percentages are given by weight and all temperatures in degrees Celsius (° C.) unless otherwise noted.

A. Measurement of Viscosity by Brabender Evaluation

Viscosity is measured using a Micro Visco-Amylo-Graph® (available from C. W. Brabender Instruments, Inc., South Hackensack, N.J.). 35.4 g of anhydrous starch is slurried in 464.6 g of distilled water and then added to the Brabender viscoamylograph bowl. The starch slurry is rapidly heated to 50° C and then heated further from 50° to 95° C. at a heating rate of 1.5° C. per minute. Viscosity readings are recorded at 80° C., 95° C. and again at 95° C. after holding at 95° C. for 20 minutes.

B. Cold Process for Cheesebread Preparation (Using Pre-Gelatinized Specialty Starches)

The following formulation is used in the cold process preparation of cheesebread

| Ingredient | % | grams |
|---|---|---|
| Tapioca Starch | 30.18 | 90.54 |
| Specialty Starch | 7.3 | 21.9 |
| NFDM (skim milk) | 2.27 | 6.81 |
| Salt | 1.14 | 3.42 |
| Shortening | 4.55 | 13.65 |
| Tap water | 18.2 | 54.6 |
| Grated cheese | 18.18 | 54.4 |
| Eggs | 18.18 | 54.4 |

The dry ingredients are combined with the cheese and oil and mixed together using a Kitchen Aid mixer with dough hook for one minute on speed 1. The eggs and water are added, and the dough mixed for 2½ minutes on speed 2, with the bowl scraped after each minute. The prepared dough is weighed on a scale to 25 grams (+/−0.5 g) and hand-formed into balls. The dough balls are then baked at 190° C. (375° F.) for 18 to 20 minutes.

C. Hot Process for Cheesebread Preparation (Using Cook-Up Fermented Starches)

The following formulation is used in the hot process preparation of cheesebread

| Ingredient | % |
|---|---|
| Fermented starch | 39.98 |
| Whole milk | 21.69 |
| Vegetable oil | 12.0 |
| Salt | 0.96 |
| Whole eggs | 14.39 |
| Grated cheese | 10.98 |

The oil, milk, and salt are heated together to 93° C. (200° F.) and brought back to weight. In a Hobart bowl with paddle the hot liquid is added to the starch. This mixture is mixed using a Kitchen Aid mixer for 30 seconds on speed 1. The mixture was then cooled to approximately 54° C. (130° F.). The eggs and cheese are added and mixed for 30 seconds on speed 1. The prepared dough is weighed on a scale to 25 grams (+/−0.5 g) and hand-formed into balls. The dough balls are then baked at 190° C. (375° F.) for 18 to 20 minutes.

D. Cheesebread Evaluation

Cheesebreads were evaluated in terms of dough handling properties and bread quality. Dough handling was judged by the ability to form dough balls with hands, and the avoidance of stickiness to the hands or the mixing bowl. Bread quality was determined based on the subjective evaluation by trained sensory panel looking for the following attributes:
Crust Color: Target color is very light golden color on the sides and top; darker on the bottom due to the hot baking surface. Small color spots that appear as orange or yellow spots (specific to the cheese) can be seen randomly on the surface. A few light brown spots can be seen on the edges where the crust has broken or cracked.
Crust Sheen: Target is very dull, e.g., comparable to an English muffin surface. Sheen is not a desirable characteristic.
Crust Crispiness: Target is a thin crisp crust. The surface of the cheese bread should be pliable and can be pushed inward while maintaining the crispiness and without having the surface crack and flake off.
Crust Thickness: Target is for a very thin (crispy) crust over the top and sides. It can be thicker on the bottom.
Crust Graininess: Target texture is for a slightly rough, grainy surface like a biscuit. It should not look or feel smooth, nor should it feel like coarse sandpaper or granulated sugar.
Cell Structure: Target product should have a coarse bread-like cell structure like homemade bread, with a few open cells. A more open structure is commonly found, but not necessarily desired.
Chewiness (based on combination of top and bottom crusts and internal crumb): The cheese bread should have a moist, chewy texture. Crust portions should be crispy, but not hard during chewing.
Elasticity: Target texture should show strands of chewy, elastic-like strands forming as a piece of cheese bread is pulled apart. A clean break is not desirable.
   The above attributes were combined and used to determine the overall quality of the breads, which was rated on a scale of from 1 to 5 with 5 being the best. The results are provided in the tables found infra.
   E. Poppy Seed Displacement Method for Determining Specific Volume

Specific volume of each baked product was determined as follows. The baked product to be tested was weighed and recorded. A container was placed on paper or foil and filled with poppy seeds. The container was tapped to settle the seeds. The top surface of the container was leveled off with a straight-edged instrument, and any excess poppy seeds put aside. One third of the leveled poppy seeds were removed from the container and reserved. The baked product was placed in the container, the reserved poppy seeds added, and the container tapped to settle the seeds. The poppy seeds were leveled off to the top surface of the container with the straight edge. The excess poppy seeds were transferred to a graduated cylinder and the cylinder tapped once lightly. The volume of the poppy seeds in the graduated cylinder was read as the volume that was displaced by the baked product. The specific volume was calculated using the following equation

Specific volume (ml/gram)=displaced volume/weight of sample

### EXAMPLE I

This example illustrates the procedure for the conversion of starch to a required Brabender viscosity, then crosslinking it with phosphorus oxychloride (‘POCl₃’). A slurry was prepared by loading 119 liters of water into a reaction tank. The agitator was turned on and its speed set to 292 rpm. The temperature of the water was adjusted to 32° C. 79 kg of tapioca starch was then added, with the viscosity in degree Baume adjusted to between 21 and 22 as necessary. 38 kg of water was added to another tank. While cooling this tank with a chilling coil, 1.2 kg of sodium hydroxide (‘NaOH’) was added to make a 3.15% solution. 15 liters of this NaOH solution was then added to the tapioca starch slurry in the other tank at a rate of 0.4 liters per minute (1/min) until the alkalinity was raised to 29 ml 0.1N HCl (50-ml sample). The pH was approximately 11.70.

3.97 g of potassium permanganate (dissolved in 132 grams water) was added to the starch slurry (0.005% based on weight of starch, which corresponds to 17.5 ppm of manganese ions based on weight of starch). This was allowed to mix for 15 minutes, followed by addition of 31.1 gm of 35% H₂O₂. This reaction was held until no hydrogen peroxide remained, as indicated by a negative test on an H₂O₂ quant strip. The resulting starch was found to have a Brabender viscosity of 500 BU.

The temperature of the starch slurry was then lowered to 27° C. 1.6 kg NaCl and 14.97 gm POCl₃ (0.0196% POCl₃ on starch weight) were added to the starch slurry and reacted for 0.5 hours to crosslink the starch. The pH of the starch slurry was then adjusted to 5.5 by neutralization with hydrochloric acid. The starch product was washed twice with water, recovered by filtration and dried.

The final product was found to have a Brabender viscosity at 80° C. of 410 BU, 430 BU at 95° C., and a Breakdown Viscosity Differential (‘BVD’) of 4.9 (BVD=100×(95° C. viscosity−80° C. viscosity)/80° C. viscosity).

### EXAMPLE II

OSA-treated tapioca starch was prepared as follows. 500 grams of tapioca starch was slurried in 750 ml water. The pH was adjusted to 7.5 using a 3% sodium hydroxide solution. 15 grams of octenyl succinic anhydride (‘OSA’) was added in one-third increments every thirty minutes while maintaining the pH at 7.5 using 3% sodium hydroxide and constant agitation. The starch was then filtered and washed with 750 ml water. The starch was then reslurried in 500 ml water and the pH adjusted to 5.5 with 3:1 hydrochloric acid. The starch was then filtered, washed with 750 ml water, and air dried.

### EXAMPLE III

This example illustrates the drum drying of the OSA-modified tapioca starch described in Example II above. The sample was drum-dried by slurrying 200-g starch in 300 ml water and drying the slurry by slowly feeding it onto a steam-heated 10 inch diameter steel drum, with steam pressure of 105-110 psi. The starch was applied to the roll just prior to a 2-inch diameter feed roller, with the drum operating at a speed of 5 RPM. The pregelatinized starch sheet was scraped off of the drum by a steel blade. The pregelatinized starch sheets thus obtained were then ground in a coffee grinder until 85% passed through a 200-mesh screen. The dried starch products were evaluated as to their effectiveness in a cheese bread formulation compared to other starch types. The results are given in Table I below

TABLE I

| | Specific | Dough | |
|---|---|---|---|
| Starch Type | Volume (ml/g) | Handling | Bread Quality |
| 1A (3% OSA waxy from | 2.3 | 4.5 | 4.0 |
| Example II) | | | |
| 1B (Control - | 2.07 | 2.0 | 2.5 |
| Fermented tapioca)* | | | |
| 1C (STMP crosslinked | 1.89 | 4.5 | 4.0 |
| (“xl”), drum dried (“DD”) | | | |
| tapioca) | | | |
| 1D (oxidized, DD | 2.3 | 4.5 | 4.0 |
| tapioca) | | | |
| 1E (DD, acetylated, xl | 4.45 | 1.5 | 2.5 |
| tapioca (from Corn | | | |
| Products Int'l (‘CPC’))* | | | |
| 1F (DD, acetylated | 2.28 | 4.5 | 4.0 |
| tapioca (from CPC)) | | | |
| 1G (0.5 acetylated | 3.19 | 1.5 | 1.5 |
| tapioca) | | | |
| 1H (1.7 acetylated | 3.84 | 1.5 | 2.0 |
| tapioca) | | | |
| 1l (0.135 POCl₃ xl, 0.5 | 1.65 | 3.0 | 1.5 |
| acetylated tapioca) | | | |

*Uses cook-up cheesebread procedure

The above results illustrate that the addition of the drum dried modified starch improves expansion, dough handling and bread quality. The results from Table I show the OSA modified starch (1A), the degraded starch (1D) and the acetylated starch (1F) to provide comparable improvements, with the crosslinked, drum dried starch (1C) providing nearly comparable improvements over the control.

### EXAMPLE IV

This example illustrates the drum drying of the converted and crosslinked tapioca starch of Example I. Five samples of the starch were prepared with various degrees of H₂O₂ conversion. The starches were crosslinked with various amounts of POCl₃ crosslinking agent. A pilot scale drum drier (available from GMF-Gouda, Waddinxveen, Holland) was used to drum-dry each converted and crosslinked tapioca starch. The drum was 50 cm wide, with a diameter of 50 cm, and was turned by a 5 HP variable speed motor. Just above the drum were arranged one reverse roll and three applicator rolls.

The converted and crosslinked tapioca starch was suspended in water to form a 21° Baume slurry, which was pH adjusted to approximately 6.5. The drum was started at 6 RPM and heated with steam (at 120 PSIG) to a surface temperature of approximately 160° C.

The slurry was pumped to the drum dryer by means of a Moyno pump (available from Moyno, Inc., Springfield, Ohio). The pump speed was adjusted to achieve a steady flow of slurry on to the second applicator roll. Once a coating was observed on the drum, a scraper knife was engaged by tightening down slowly on the knife bolts until a clean drum surface was noted.

The drum-dried starch film was then scraped into a conveying screw, which directed the scraped material into a waste hopper. Once a full sausage was obtained between the third and fourth applicator roll, and the sheets were uniform, the product was collected into a container. This material was then ground in a hammer mill until a particle size of approximately 200-mesh (74 microns) was obtained.

These drum-dried starch products were evaluated as to their effectiveness in a cheese bread formulation. The results are given in Table II below

TABLE II

| | | Brabender | | | | | |
|---|---|---|---|---|---|---|---|
| | | Peak | | | Specific | | |
| | | Viscosity | % POCL₃ | | Volume | Dough | Bread |
| BATCH | % H₂O₂ | (Base Starch) | Treatment | BVD | (ml/g) | Handling | Quality |
| 2A | 0.05 | 370 | 0.012 | −10.8 | 2.98 | 3 | 2.5 |
| 2B | 0.02 | 1020 | 0.012 | −21 | 3.44 | 2 | 1.5 |
| 2C | 0.02 | 1120 | 0.014 | +20 | 2.59 | 4.5 | 3.5 |
| 2D | 0.035 | 490 | 0.012 | −16.9 | | Too poor | |
| | | | | | | for analysis | |
| 2E | 0.02 | 1010 | 0.013 | −8.26 | 3.5 | 2.5 | 2.5 |
| 2F | 0.039 | 500 | 0.0196 | +5 | 2.99 | 4.0 | 4.5 |

Table II shows the degree of degradation or conversion and the amount of crosslinking affects bread expansion (specific volume), dough handling and bread quality. According to Table II, those starches that have been only slightly converted (i.e., with about 0.040 or less H₂O₂) and have been moderately crosslinked (i.e., treated with about 0.014 or more POCl₃) provide bread products having acceptable expansion, dough handling and bread quality.

### EXAMPLE V

This example illustrates the effect of water level on bread. The starch sample from Example IV providing the highest bread quality (2F) was tested in a cheesebread formula whereby the water was decreased. Results are shown in Table III

TABLE III

| | Water Content | Specific | Dough | |
|---|---|---|---|---|
| Sample | of Dough (%) | Volume | Handling | Bread Quality |
| 2F | 18.2 | 2.99 | 4.0 | 4.5 |
| 2F | 16.1 | 2.92 | 4.5 | 4.0 |

Table III shows that the amount of water in the dough affects dough handling, indicating that an optimal level of water exists in the dough.

### EXAMPLE VI

To optimize dough and bread quality and expansion, the ratio or amount of modified and unmodified starch in the total dough formulation (cold process) was altered using a sample of 2F-type starch made with various ratios of unmodified tapioca starch from Thailand. Results are shown in Table IV

TABLE IV

| | Percentage of | | | |
|---|---|---|---|---|
| | unmodified to modified | | | |
| | starch (% based on | Specific | Dough | Bread |
| Sample | total weight) | Volume | Handling | Quality |
| 2F | 30.18:7.3 | 2.33 | 4.0 | 4.5 |
| 2F | 31.86:5.62 | 3.42 | 4.0 | 4.0 |
| 2F | 28.11:9.37 | 2.33 | 4.5 | 4.0 |

As seen from Table IV, specific volume (i.e., the amount of expansion) is increased by increasing the percentage of native (unmodified) tapioca flour and reducing the percentage modified starch in the total amount of ingredients used in forming the bread, with only a slight reduction in bread quality. Increasing the percentage of modified starch and reducing the percentage of unmodified starch improves dough handling without reducing expansion.

### EXAMPLE VII

This example illustrates the effect of different cheeses on breads made with starches of the present invention. Cheesebread was made with a variety of cheese types. The effect of those cheeses on the quality of the bread is shown below in Table V

TABLE V

| Starch | | Specific | Dough | |
|---|---|---|---|---|
| Sample | Cheese type | Volume | Handling | Bread Quality |
| 1C | Keijoban | 1.89 | 4.5 | 4.0 |
| 1C | Kraft | 1.27 | 4.5 | 4.0 |
| | Parmesan | | | |
| 1C | Cheddar | 1.63 | 4.5 | 3.5 |
| 1C | Edam | 1.41 | 4.5 | 3.0 |
| 1C | Fresh | 2.23 | 4.5 | 3.0 |
| | Parmesan | | | |
| 1C | Farmers | 1.41 | 4.5 | 3.5 |
| 1C | Havarti | 1.52 | 4.5 | 3.5 |

Although the present invention has been described and illustrated in detail, it is to be clearly understood that the same is by way of illustration and example only, and is not to be taken as a limitation. The spirit and scope of the present invention are to be limited only by the terms of any claims presented hereafter.

1. A gluten-free baked product obtained from a mixture of starting materials comprising:
at least one modified starch for expansion of the baked product.

2. The baked product of claim 1 wherein the modified starch is a converted starch.

3. The baked product of claim 2 further wherein the modified starch is a crosslinked starch.

4. The baked product of claim 2 further wherein the modified starch is a drum dried starch.

5. The baked product of claim 1 wherein the modified starch is a tapioca starch.

6. The baked product of claim 1 wherein the modified starch is a crosslinked starch.

7. The baked product of claim 3 wherein the crosslinked starch is crosslinked with POCl₃.

8. The baked product of claim 1 wherein the modified starch is an OSA-modified starch.
